(19) United States
(12) Patent Application Publication
(10) Pub. No.: US 2013/0258851 A1
(43) Pub. Date: Oct. 3, 2013

(54) MITIGATION OF CONGESTION DUE TO STUCK PORTS IN NETWORK SYSTEMS

(71) Applicants: Deepak Srinivas Mayya, Fremont, CA (US); Rajesh L G, Bangalore (IN); Saket Jain, New Delhi (IN); Prashant Chandrashekhar Pathak, Bangalore (IN); Lalit Kumar, Fremont, CA (US); Ranganathan Rajagopalan, Fremont, CA (US)

(72) Inventors: Deepak Srinivas Mayya, Fremont, CA (US); Rajesh L G, Bangalore (IN); Saket Jain, New Delhi (IN); Prashant Chandrashekhar Pathak, Bangalore (IN); Lalit Kumar, Fremont, CA (US); Ranganathan Rajagopalan, Fremont, CA (US)

(73) Assignee: Cisco Technology, Inc., San Jose, CA (US)

(21) Appl. No.: 13/435,350

(22) Filed: Mar. 30, 2012

(51) Int. Cl. H04L 12/26

(52) U.S. Cl. 370/235

(57) ABSTRACT

In one embodiment, a method is provided for controlling congestion in a network system. In this method, receipt of a data packet that is destined for a destination switching apparatus is detected. Subsequent to the detection of the data packet, a time that has elapsed while flow control is implemented by the destination switching apparatus is tracked. The data packet is dropped based on the elapsed time exceeding a predefined time period.

### FIELD

The present disclosure relates generally to communication systems.

### BACKGROUND

Data packets are transmitted within a network system, such as a Fibre Channel network. To prevent a recipient device (e.g., a storage server) from being overwhelmed with incoming data packets, many network systems provide flow control mechanisms based on, for example, a system of buffer-to-buffer credits. Each buffer-to-buffer credit represents the ability of a recipient device to accept additional data packets. If a recipient device issues no credits to the sender, the sender cannot send any additional data packets. This control of the data packet flows based on buffer-to-buffer credits helps prevent the loss of data packets and also reduces the frequency of need of data packets to be retransmitted across the network system. It should be appreciated that switches, that connect various network segments in the network system, buffer all incoming data packets. Because of the way many of these buffers are designed to operate, deadlock conditions can occur when a switch loses all buffer-to-buffer credits.

### BRIEF DESCRIPTION OF DRAWINGS

The present disclosure is illustrated by way of example and not limitation in the figures of the accompanying drawings, in which like references indicate similar elements and in which:

FIG. 1A is a block diagram depicting a network system for communicating data packets, in accordance with an example embodiment;

FIG. 1B is a block diagram depicting a network system having a deadlock condition, in accordance with an example embodiment;

FIG. 2 depicts an example of an output queue included in a switching apparatus;

FIG. 3 is a block diagram illustrating an example embodiment of a switching apparatus that is configured for mitigation of congestion due to stuck ports in a network system;

FIG. 4 is a flow diagram of a general overview of a method, in accordance with an example embodiment, for mitigating congestion due to stuck ports in a network system;

FIG. 5 is a timing diagram depicting various data transmitted between components in a Fibre Channel network system that supports mitigation of congestion due to stuck ports, in accordance with an example embodiment; and

FIG. 6 is a flow diagram depicting a more detailed method, in accordance with an embodiment, for mitigating congestion due to stuck ports in a Fibre Channel network system.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

### Overview

A method is provided for controlling congestion due to stuck ports in a network system. In this method, receipt of a data packet that is destined for a destination switching apparatus is detected. Subsequent to the detection of the data packet, a time that has elapsed while flow control is implemented by the destination switching apparatus is tracked. The data packet is dropped based on the elapsed time exceeding a predefined time period.

### Example Embodiments

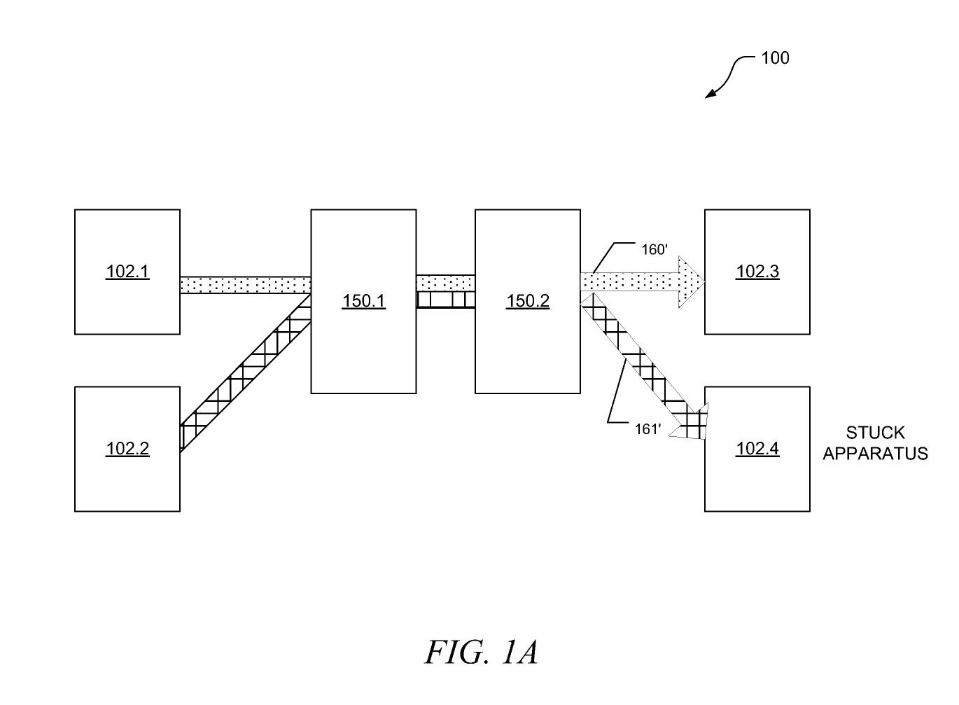

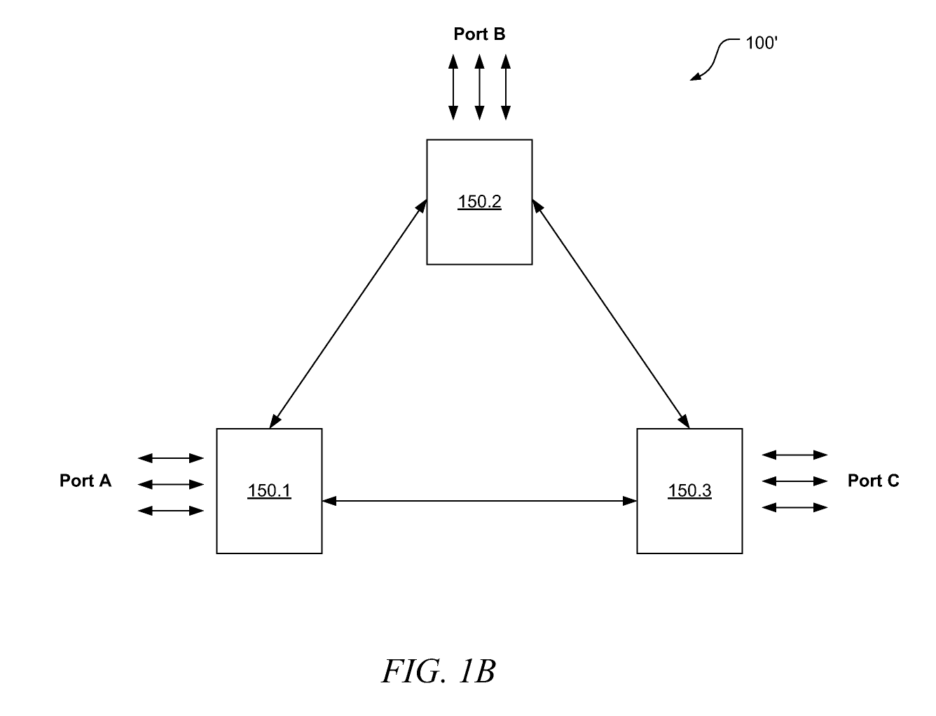

FIG. 1A is a block diagram depicting a network system 100 for communicating data packets, in accordance with an example embodiment. The network system 100 includes edge apparatuses 102.1-102.4 and switching apparatuses 150.1-150.2. In one example, the network system 100 can be a storage area network (SAN), which is a high-speed network that enables establishment of direct connections between storage system and its storage devices. The SAN may thus be viewed as an extension to a storage bus and, as such, an operating system of storage system enables access to stored data using block-based access protocols over an extended bus. In this context, the extended bus can be embodied as Fibre Channel, Computer System Interface (SCSI), Internet SCSI (iSCSI) or other network technologies.

As depicted, the edge apparatuses 102.1 and 102.2 are transmitting data packets 160′ and 161′ to edge apparatuses 102.3 and 102.4, respectively, by way of switching apparatuses 150.1 and 150.2. As explained in detail below, the switching apparatuses 150.1 and 150.2 are computer networking apparatuses that connect various network segments. In this example, the flow of packets 161′ to edge apparatus 102.4 is congested because, for example, this particular edge apparatus 102.4 has a stuck port, which is explained in detail below. However, this congestion associated with edge apparatus 102.4 can negatively affect the flow of data packets to other edge apparatuses as well, such flow of data packets 160′ to edge apparatus 102.3.

In particular, congestion can affect other flows because of how flow control signals are buffered in the network system 100. In general, flow control refers to stopping or resuming transmission of data packets. A “flow control signal,” as used herein, refers to a signal transmitted between two apparatuses to control the flow of data packets between each other. An example of a flow control signal is a pause command (or pause frame) used in Ethernet flow control. It should be appreciated that pause command signals the other end of the connection to pause transmission for a certain amount of time, which is specified in the command.

Another example of a flow control signal is a buffer-to-buffer credit used in Fibre Channel flow control. A “buffer-to-buffer credit,” as used herein, identifies a number of data packets that are allowed to accumulate on a destination apparatus. Particularly, in buffer-to-buffer credit control, two connected apparatuses in the network system 100 (e.g., switching apparatus 150.2 and edge apparatus 102.4 or switching apparatuses 150.1 and 150.2) set a number of unacknowledged frames allowed to accumulate before a sending apparatus, which initiates transmission, stops sending data to a destination apparatus, which receives the frames. It should be appreciated that a “frame,” refers to a data packet that includes frame synchronization. Thus, in effect, a frame is a data packet and therefore, the terms may be used interchangeably.

A counter at the sending apparatus keeps track of a number of buffer-to-buffer credits. Each time a frame is sent by the sending apparatus, the counter increments by one. Each time the destination apparatus receives a frame, it sends an acknowledgement back to the sending apparatus, which decrements the counter by one. If the number of buffer-to-buffer credits reaches a maximum limit, the sending apparatus stops transmission until it receives a next acknowledgement from the destination apparatus. As a result, the use of such buffer-to-buffer credit mechanism prevents loss of frames that may result if the sending apparatus races too far ahead of a destination apparatus's ability to process the frames.

It should be appreciated that buffer-to-buffer credit limit reaching a maximum is equivalent to receiving a pause command, which is described above. In Ethernet flow control, an edge device 102.4, which processes data packets slower than switching apparatus 150.2, causes the output queue in the switching apparatus 150.2 to fill up. As a result, in a system with lossless arbitration scheme, the input queue in the switching apparatus 105.2 is also filled up. When the input queue fills up, the switching apparatus 105.2 flow controls switching apparatus 150.1 that causes congestion for all the flows destined to switching apparatus 150.2.

FIG. 1B is a block diagram depicting a network system 100′ having a deadlock condition, in accordance with an example embodiment. As depicted, Port A transmits traffic (or data packets) to port C by way of switching apparatus 150.2. Port B transmits traffic to Port A through switching apparatus 150.3. Port C transmits traffic to Port B through switching apparatus 150.1. As used herein, a “port” refers to a logical channel or channel endpoint in a network system. For example, a Fibre Channel port is a hardware pathway into and out of a node that performs data communications over a Fibre Channel link.

In this example, if any one of the links that connect the switching apparatuses 150.1-150.3 loses all buffer-to-buffer credits, then a deadlock condition can result for all Ports A, B, and C where all the switches 150.1-150.3 stop transmitting traffic between each other, thereby resulting in stuck ports. In particular, a deadlock condition can occur because of how flow control signals are buffered in the network system 100′, as explained in detail below.

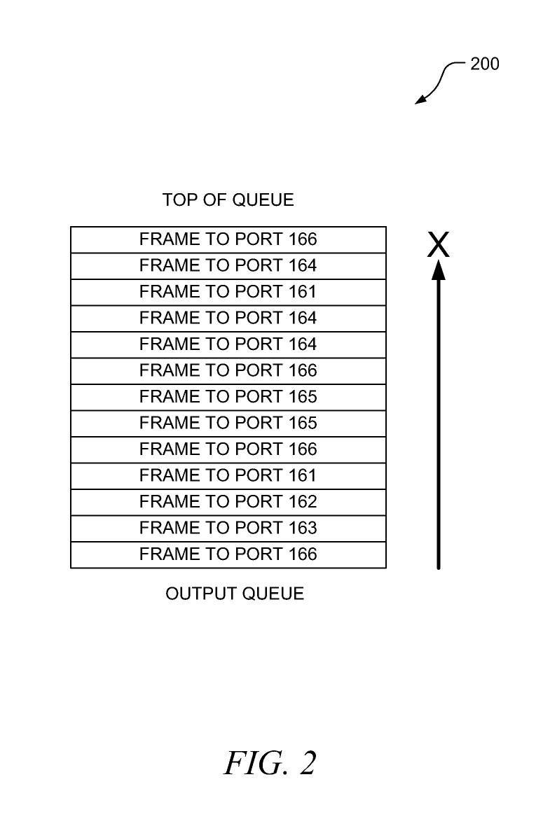

FIG. 2 depicts an example of an output queue 200 included in a switching apparatus, such as the switching apparatus 150.1 depicted in FIG. 1. In reference to FIG. 2, this output queue 200 is configured to buffer frames outputted to various ports, such as ports 161-166. As used herein, a “port” refers to a logical channel or channel endpoint in a network system. For example, a Fibre Channel port is a hardware pathway into and out of a node that performs data communications over a Fibre Channel link.

Given that the output queue 200 buffers all frames to multiple ports 161-166, in the event of a congestion of an output port, all the buffered frames behind the congested port are blocked or delayed. For example, port 166 is destined to an apparatus that processes its data packets slower than the other destination apparatuses. Thus, a flow of frames to port 166 becomes congested and therefore, the transmission of other frames to the same port 166 as stored in the output queue 200 is delayed. However, all the frames to other ports 161-165 are also stored and queued in the output queue 200, but cannot move up in the queue until the top of the queue, which includes frame to port 166, has been cleared. Thus, as depicted in FIG. 2, the delay in clearing frames to port 6 from the output queue 200 also blocks transmission of frames to other ports 1-5, therefore resulting in a deadlock condition.

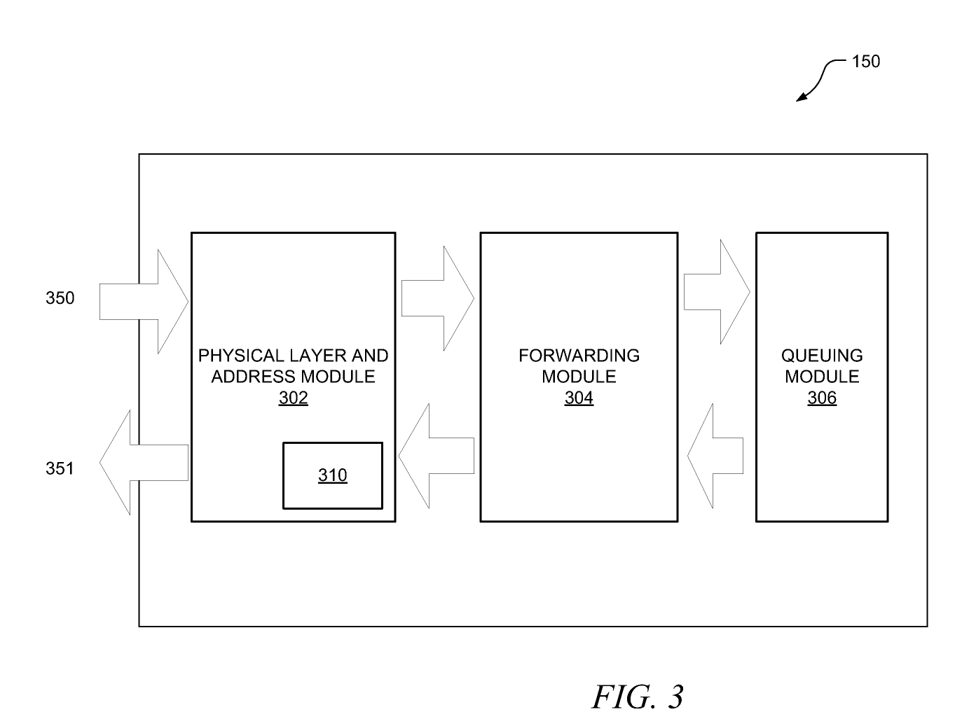

FIG. 3 is a block diagram illustrating an example embodiment of a switching apparatus 150 that is configured for mitigation of congestion due to stuck ports in a network system. It should be appreciated that this embodiment of the switching apparatus 150 may be included in, for example, the network system depicted in FIG. 1. Referring back to FIG. 3, in various embodiments, the switching apparatus 150 may be used to implement computer programs, logic, applications, methods, or processes to control congestion in a network system, as described in detail below.

The switching apparatus 150 is a device that channels incoming data packets 350 from multiple input ports to one or more output ports that forward the output data packets 351 toward their intended destinations. For example, on an Ethernet local area network (LAN), the switching apparatus 150 determines which output port to forward each incoming data packet 350 based on the physical device address (e.g., Media Access Control (MAC) address). In a wide area packet-switched network (WAN), such as the Internet, the switching apparatus 150 determines from an Internet Protocol (IP) address in each data packet which output port to use for the next part of its trip to the intended destination. In an Open Systems Interconnection (OSI) communications model, the switching apparatus 150 performs the Layer 2 or Data-link layer function. In another example, the switching apparatus 150 can also perform routing functions associated with Layer 3 or network layer functions in OSI.

In this embodiment, the switching apparatus 150 includes a physical layer and address module 302, a forwarding module 304, and a queuing model 306. In general, the physical layer and address module 302 converts, for example, optical signals received into electrical signals, and sends the electrical stream of bits into, for example, the MAC, which is included in the physical layer and address module 302. The primary function of the MAC is to decipher Fibre Channel data packets from the incoming bit stream. In conjunction with data packets being received, the MAC communicates with the forwarding and queuing modules 304 and 306, respectively, and issues return buffer-to-buffer credits to the sending apparatus to recredit the received data packets. Additionally, as explained in detail below, the physical layer and address module 302 includes port logic module 310 that, as one of its function, is configured for congestion control.

The forwarding module 304 is configured to determine which output port on the switching apparatus 150 to send the incoming data packets 350. The forwarding can be based on a variety of lookup mechanisms, such as per-virtual storage area network (VSAN) forwarding table lookup, statistics lookup, and per-VSAN Access Control Lists (ACL) lookup.

The queuing module 306 is primarily configured to schedule the flow of data packets through the switching apparatus 150. As described above, queuing module 306 provides frame buffering for queuing of received data packets. In one embodiment, as explained in detail below, the port logic module 310 can provide instructions related to congestion control to the queuing module 306.

It should be appreciated that in other embodiments, the switching apparatus 150 may include fewer or more modules apart from those shown in FIG. 3. The modules 302, 304, 306, and 310 may be in the form of firmware that is processed by application specific integrated circuits (ASIC), which may be integrated into a circuit board. Alternatively, the modules 302, 304, 306, and 310 may be in the form of one or more logic blocks included in a programmable logic device (e.g., a field programmable gate array). The described modules 302, 304, 306, and 310 may be adapted, and/or additional structures may be provided, to provide alternative or additional functionalities beyond those specifically discussed in reference to FIG. 3. Examples of such alternative or additional functionalities will be discussed in reference to the flow diagrams discussed below.

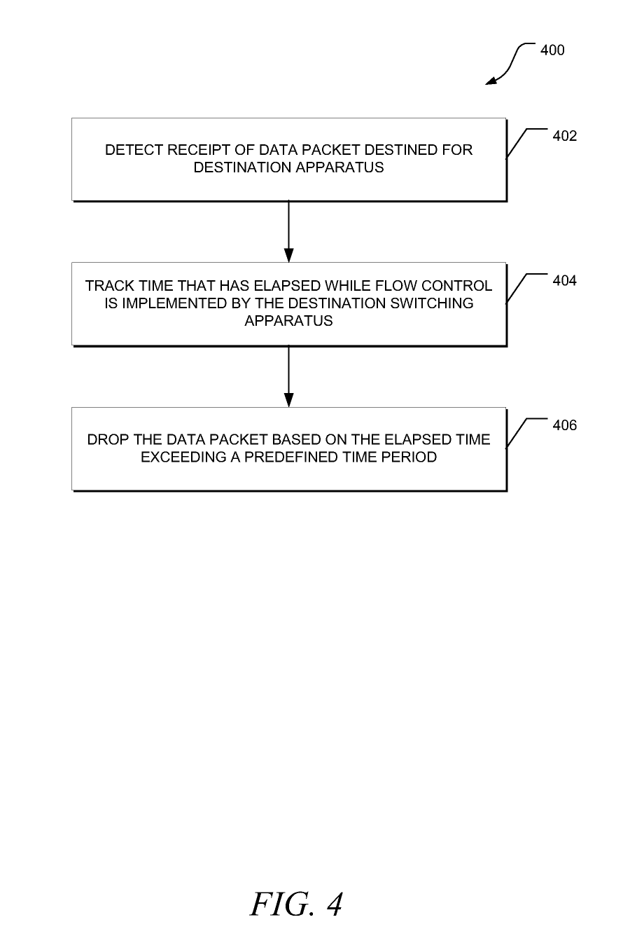

FIG. 4 is a flow diagram of a general overview of a method 400, in accordance with an example embodiment, for mitigating congestion due to stuck ports in a network system. In an example embodiment, the method 400 may be implemented by the port logic module 310 employed in the switching apparatus 150 depicted in FIG. 3.

As depicted, in FIG. 4, the port logic module detects receipt of data packets, at 402, that are destined for or to be forwarded to a destination apparatus. In one embodiment, the port logic module can make such a detection by detecting whether the data packet is stored in an output queue.

Subsequent to the detection of the data packet, the port logic module, at 404, tracks a time that has elapsed while flow control is implemented by the destination switching apparatus. It should be appreciated that flow control is implemented by communicating flow control signals. Therefore, as explained in detail below, the time can be tracked based on receipt of flow control signals. The data packet is dropped at 406 if the elapsed time exceeds a predefined time period. However, if the switching apparatus receives a flow control signal from the destination apparatus within the predefined time period, then the port logic module in the switching apparatus forwards the data packet to the destination apparatus. In other words, as also explained in detail below, data packets are dropped if elapsed time exceeds a predefined time period if flow control is ON. If flow control is turned OFF within predefined time period, data packets are forwarded.

It should be noted that the predefined time period can be defined by a user, and can range, for example, between 10-900 milliseconds. This predefined time period may be based on a length of a cable (e.g., Fibre Channel cable) connecting the switching apparatuses. The predefined time period can be based on the length because the transit time for a data packet to be communicated from one switching apparatus to another switching apparatus depends on the length of the cable and therefore, the port logic module needs to be provided a certain time period to account for the transit time.

To track the elapsed time, the port logic module can, in one example embodiment, initiate a timer that is configured to measure the elapsed time. Comparisons are made between the elapsed time and the predefined time period. The port logic module then drops or forwards the data packet in reference to the comparison. For example, the port logic module can drop the data packet if the elapsed time exceeds the predefined time period.

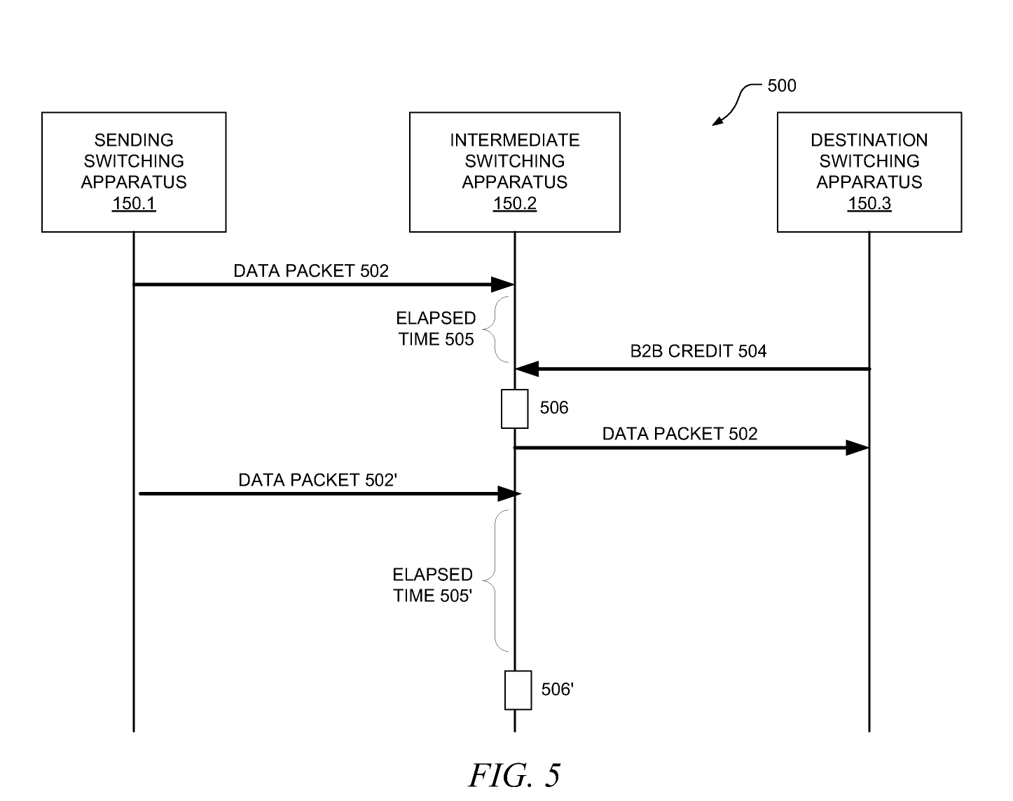

FIG. 5 is a timing diagram depicting various data transmitted between components 150.1-150.3 in a Fibre Channel network system 500 that supports mitigation of congestion due to stuck ports, in accordance with an example embodiment. In this example, the Fibre Channel network system 500 includes a sending switching apparatus 150.1, an intermediate switching apparatus 150.2, and a destination switching apparatus 150.3. The sending switching apparatus 150.1 transmits a data packet 502 associated with a particular port to the destination switching apparatus 150.3 by way of the intermediate switching apparatus 150.2. After receipt of the data packet 502, the intermediate switching apparatus 150.2 tracks a time 505 that has elapsed until receipt from the destination switching apparatus 150.3 of a buffer-to-buffer credit 504. If the elapsed time 505 exceeds a predefined time period, the intermediate switching apparatus 150.2 is configured to drop the data packet 502. If the elapsed time 505 falls below the predefined time period, the intermediate switching apparatus 150 is configured to forward the data packet 502 to the destination switching apparatus 150.3.

As depicted in FIG. 5, the intermediate switching apparatus 150.2 receives a buffer-to-buffer credit (B2B) 504 from the destination switching apparatus 150.3 within the predefined time period. That is, the tracked elapsed time 505 is less than the predefined time period. As a result, at 506, the intermediate switching apparatus 150.2 forwards the data packet 502 to the destination switching apparatus 150.3.

Thereafter, the sending switching apparatus 150.1 transmits another data packet 502′ to intermediate switching apparatus 150.2 to forward to the destination switching apparatus 150.3. Upon detection of the receipt of the data packet 502′, the intermediate switching apparatus 150.2 tracks a further time 505′ that has elapsed without receipt of a buffer-to-buffer credit from the destination switching apparatus 150.3. In this example, the elapsed time 505′ has exceeded the predefined time period. As a result, the intermediate switching apparatus 150.2 is configured to drop the data packet 502′ at 506′.

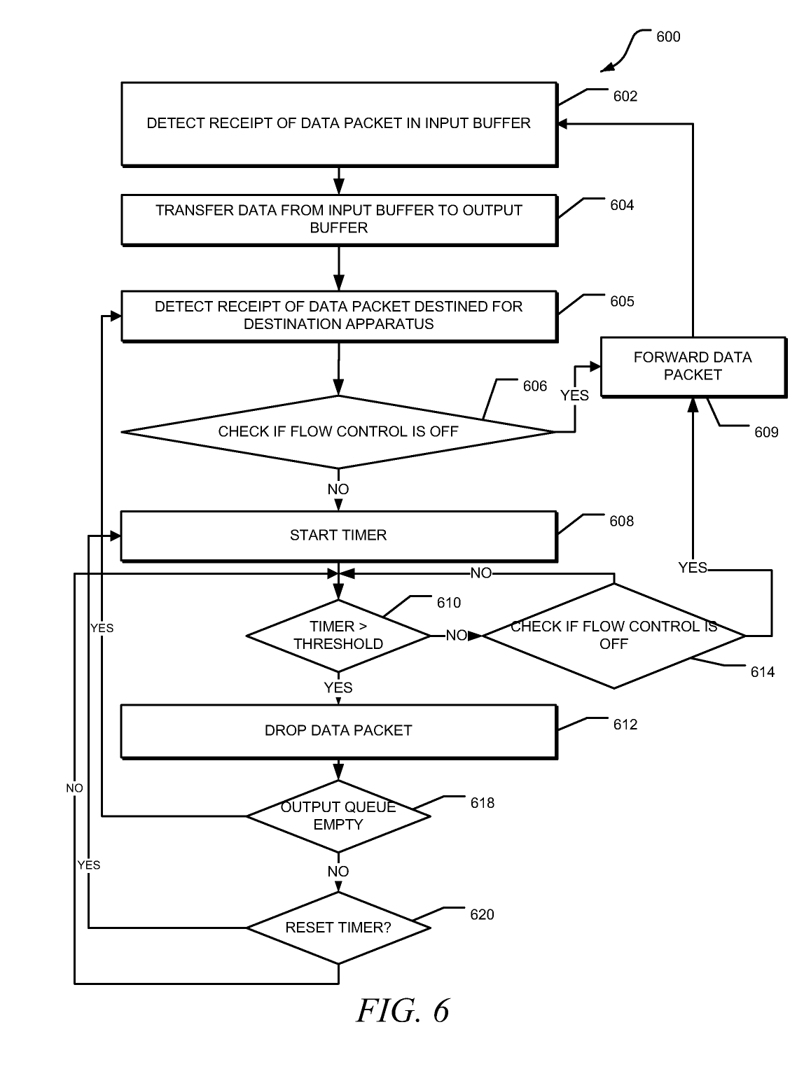

FIG. 6 is a flow diagram depicting a more detailed method 600, in accordance with an embodiment, for mitigating congestion due to stuck ports in a Fibre Channel network system. In this example embodiment, the method 600 may be also implemented by the port logic module 310 and employed in the switching apparatus 150 depicted in FIG. 3.

In reference to FIG. 6, the port logic module initially detects the receipt of a data packet. For example, at 602, the port logic module can make such a detection based on detection of receipt of the data packet in an input queue associated with an input port. At 604, this data packet is then transferred from the input queue to an output queue that is associated with an output port. The transfer can be by way of a lossless mechanism. The port logic module then makes the detection of the receipt of the data packet by detecting the storage of the data packet in an output queue at 605.

Afterwards, the switching apparatus, at 606, checks whether flow control is off. For example, in one embodiment, the switching apparatus can check whether a pause command has been asserted. In an alternate embodiment, the switching apparatus can check if buffer-to-buffer credit is available (or received from the destination apparatus). If buffer-to-buffer credit is available, then the port logic module forwards the data packet to the destination apparatus at 609. However, if buffer-to-buffer credit is not available, then the port logic module starts a timer, at 608, to track the time period that has elapsed without receipt of a buffer-to-buffer credit. For example, the port logic module can track based on tracking a number of cycles an ASIC has a pending data packet without buffer-to-buffer credit.

In one embodiment, the port logic module, at 610, compares the timer to a threshold, which, as described above, can be pre-defined based on, for example, the length of a Fibre Channel cable. If the timer is less than the threshold, as determined at 610, then the port logic module checks again, at 614, to determine whether flow control is off. For example, in Fiber Channel networks, flow control is off if buffer-to-buffer credits is greater than 0. In Ethernet networks, flow control is off if pause is not asserted. If flow control is off, then the port logic module forwards the data packet, at 609, to the destination apparatus. However, if flow control is on, then the port logic module repeats the comparison at 610.

On the other hand, if the port logic module, at 610, identifies that the timer is greater than the threshold, then the port logic module drops subsequently received data packets destined to the destination apparatus, at 612, until the flow control is turned off. In an alternate embodiment, the timer can be a countdown timer. Here, the port logic module initiates a timer to count down from a predefined time period. If the switching apparatus receives a buffer-to-buffer credit before expiration of the timer, the port logic module forwards the data packet to the destination switching apparatus. However, if the timer expires without receipt of a buffer-to-buffer credit, then the port logic module drops the data packet at the output port.

The port logic module then checks, at 618, if there are other data packets in the output queue. If there are data packets in the output queue, the timer, at 620, can be reset to 0. Alternatively, the timer continues from the current value and data packets are continuously dropped until output queue becomes empty or a buffer-to-buffer credit, as an example, is received. However, if the output queue is empty, as checked at 618, the timer can also be reset to 0 then the port logic module repeats 605.

Certain embodiments are described herein as including logic or a number of components, modules, or mechanisms. Modules may constitute hardware modules. A hardware module is a tangible unit capable of performing certain operations and may be configured or arranged in a certain manner. In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

While the embodiment(s) is (are) described with reference to various implementations and exploitations, it will be understood that these embodiments are illustrative and that the scope of the embodiment(s) is not limited to them. In general, techniques for mitigation of congestion due to stuck ports may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. An apparatus comprising:
an output port;
a port logic module in communication with the output port, the port logic module having instructions that cause operations to be performed, the operations comprising;
detecting receipt of a data packet destined for the output port that is in communication with a destination switching apparatus;
subsequent to the detection of the data packet, tracking a time that has elapsed while flow control is implemented by the destination switching apparatus; and
dropping the data packet based on the elapsed time exceeding a predefined time period.

2. The apparatus of claim 1, further comprising an output queuing module in communication with the port logic module, the output queuing module includes an output queue, and wherein the operation of detecting the receipt of the data packet comprising detecting that the data packet is stored in the output queue.

3. The apparatus of claim 2, wherein the data packet is dropped at the output queue.

4. The apparatus of claim 1, the operations further comprising receiving a flow control signal from the destination switching apparatus, wherein the flow control signal is a buffer-to-buffer credit that identifies a number of data packets allowed to accumulate on the destination switching apparatus.

5. The apparatus of claim 1, the operations further comprising receiving a flow control signal from the destination switching apparatus, wherein the flow control signal is a pause command.

6. The apparatus of claim 1, further comprising a timer, wherein the operation of tracking the elapsed time comprises initiating the timer to count down from the predefined time period, and wherein the data packet is dropped based on an expiration of the timer.

7. Logic encoded on one or more non-transitory, tangible media and when executed cause operations to be performed, the operations comprising:
detecting receipt of a data packet destined for a destination switching apparatus;
subsequent to the detection of the data packet, tracking a time that has elapsed while flow control is implemented by the destination switching apparatus; and
dropping the data packet based on the elapsed time exceeding a predefined time period.

8. The logic of claim 7, the operations further comprising comparing the elapsed time with the predefined time period, wherein the operation of tracking the elapsed time comprises initiating a timer that is configured to measure the elapsed time, and wherein the data packet is dropped in reference to the comparison.

9. The logic of claim 7, wherein the operation of tracking the elapsed time comprises initiating a timer that is configured to count down from the predefined time period, wherein the data packet is dropped based on an expiration of the timer.

10. The logic of claim 7, wherein the data packet is destined for the destination switching apparatus by way of an output queue and wherein the data packet is dropped at the output queue.

11. The logic of claim 7, wherein the operation of detecting the receipt of the data packet comprises detecting that the data packet is stored in an output queue.

12. The logic of claim 7, the operations further comprising receiving a flow control signal from the destination switching apparatus, and wherein the flow control signal is a buffer-to-buffer credit that identifies a number of data packets allowed to accumulate on the destination switching apparatus.

13. The logic of claim 7, the operations further comprising receiving a flow control signal from the destination switching apparatus, and wherein the flow control signal is a pause command.

14. A method comprising:
detecting receipt of a data packet destined for a destination switching apparatus;
subsequent to the detection of the data packet, tracking a time that has elapsed while flow control is implemented by the destination switching apparatus; and
dropping the data packet based on the elapsed time exceeding a predefined time period.

15. The method of claim 14, further comprising comparing the elapsed time with the predefined time period, wherein the tracking of the elapsed time comprises initiating a timer that is configured to measure the elapsed time, and wherein the data packet is dropped in reference to the comparison.

16. The method of claim 14, wherein the tracking the elapsed time comprises initiating a timer that is configured to count down from the predefined time period, wherein the data packet is dropped based on an expiration of the timer.

17. The method of claim 14, wherein the data packet is destined for the destination switching apparatus by way of an output queue and wherein the data packet is dropped at the output queue.

18. The method of claim 14, wherein the detection of the receipt of the data packet comprises detecting that the data packet is stored in an output queue.

19. The method of claim 14, further comprising receiving a flow control signal, and wherein the flow control signal is a pause command.
